(19) United States
(12) Patent Application Publication
(10) Pub. No.: US 2021/0166313 A1
(43) Pub. Date: Jun. 3, 2021

(54) QUASI-DECENTRALIZED FINANCIAL INVESTMENT SYSTEM BASED ON BLOCKCHAIN

(71) Applicant: Chao-Ming CHO, Taipei City (TW)

(72) Inventor: Chao-Ming CHO, Taipei City (TW)

(21) Appl. No.: 17/104,721

(22) Filed: Nov. 25, 2020

(30) Foreign Application Priority Data
Nov. 28, 2019 (TW) 108143522

(51) Int. Cl. G06Q 40/04; G06Q 10/10; G06Q 40/08; G06Q 20/38; G06Q 40/02; G06Q 20/12; G06Q 20/40; G06Q 50/18; G06Q 20/06; G06N 20/00

(52) U.S. Cl. CPC G06Q 40/04; G06Q 10/10; G06Q 40/08; G06Q 20/389; G06Q 40/025; G06Q 2220/00; G06Q 20/405; G06Q 50/18; G06Q 20/0655; G06N 20/00; G06Q 20/127

(57) ABSTRACT

The present invention relates to a quasi-decentralized financial investment system based on blockchain, comprising: a computer device in risk investment end used for providing a risk taker to execute high-leverage risk trading; a computer device in stable income investment end used for providing a fixed income holder to receive interest every month.; a quantitative platform, such as, mirror trading platform, escrow trading platform, storing selected investment strategy program used for executing high-leverage risk trading; and, smart contract including risk collateral module and investment interest exchange contract module, wherein the risk collateral module stores cryptocurrency invested by risk takers and fixed income holders, respectively, investment interest exchange contract module stores data of investment interest exchange contract rules, and the smart contract executes capital gains distribution stored in the risk collateral module according to the data of investment interest exchange contract rules.

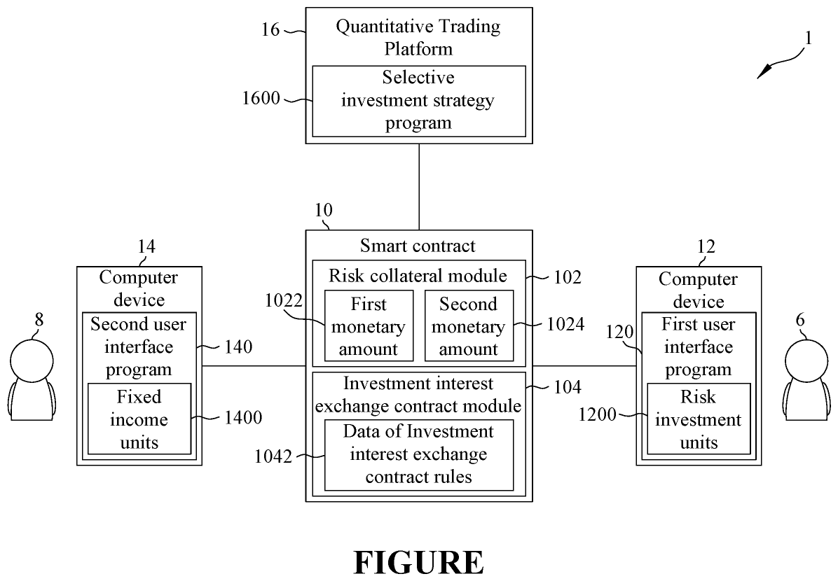

### CROSS-REFERENCE TO RELATED APPLICATION

This application claims the priority of Taiwanese patent application No. 108143522, filed on Nov. 28, 2019, which is incorporated herewith by reference.

### BACKGROUND OF THE INVENTION

### 1. Field of the Invention

The present invention generally relates to a financial investment system, and in particular, to a quasi-decentralized financial investment system based on blockchain.

### 2. The Prior Arts

DeFi stands for Decentralized Finance, which aims to allow traditional financial products to interact in a confident and transparent way through open source software and a decentralized network. Since the continuous development of Bitcoin and ETH (Ethereum), the concept of DeFi has attracted attention for only several years, and basically, the DeFi can develop and focus on the market of the business scope of the traditional banking services.

The DeFi platform can provide debt collateral commodities, such as loans, bonds, financial derivatives, collateral loan, etc.

Therefore, how to, under the concept of lending DeFi commodities, effectively match the capital demands of proceeding the high risk investments of the high risk takers and the capital demands of proceeding conservative lending income of the low risk holders, effectively solve the occurrence of fraudulent misconduct in financial investment and generation trading, and effectively verify the authenticity of the data security guaranteed to be unaltered, thus protecting the assets of the investors, is a goal for the investment areas to be achieved.

### SUMMARY OF THE INVENTION

The primary object of the present invention is to provide a quasi-decentralized financial investment system based on blockchain.

To achieve the above object, the present invention provides a quasi-decentralized financial investment system based on blockchain. The quasi-decentralized financial investment system based on blockchain, applicable to a blockchain network executing smart contract, which comprises: a computer device in risk investment end including a first user interface program for a risk taker to set subscription quantities of risk investment units and execute through the first user interface program to allow the computer device in risk investment end execute the high leverage risk trading provided by the quasi-decentralized financial investment system based on blockchain; a computer device in fixed income end including a second user interface program for a fixed income holder to set subscription quantities of fixed income units and execute through the second user interface program to allow the computer device in fixed income end execute the low risk monthly profit trading provided by the quasi-decentralized financial investment system based on blockchain; a quantitative platform, such as, mirror trading platform, escrow trading platform, stored selective investment strategy program for executing high leverage risk trading; and smart contract connected to the computer device in risk investment end, the computer device in fixed income end, and the quantitative platform, such as, mirror trading platform, escrow trading platform, respectively. The smart contract further includes risk collateral module and investment interest exchange contract module, wherein first monetary amount corresponding to subscription quantities of risk investment units of the risk traders, and second monetary amount corresponding to subscription quantities of fixed income units of the fixed income holders are stored in the risk collateral module, data of investment interest exchange contract rules between the computer device in risk investment end and the computer device in fixed income end, the computer device in fixed income end and the quantitative platform, such as, mirror trading platform, escrow trading platform, and, the computer device in risk investment end and the quantitative platform, such as, mirror trading platform, escrow trading platform, are all stored in the investment interest exchange contract module. The smart contract executes capital gains distribution of the first monetary amount and the second monetary amount stored in the risk collateral module according to the data of investment interest exchange contract rules.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIGURE is a schematic view of a quasi-decentralized financial investment system based on blockchain, applicable to a blockchain network executing smart contract, according the present invention.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Moreover, as used in the scope of the patent application, the term “a” can mean one or a plural group. That is to say, the “a” mentioned in the scope of the patent application is not limited to one, and may include one or more (that is, plural). For example, a computer device in risk investment end described in Claim 1 of the patent application means that the computer device in risk investment end can be one or more.

FIGURE is a schematic view of a quasi-decentralized financial investment system based on blockchain, applicable to a blockchain network executing smart contract, according the present invention. As shown in FIGURE, the quasi-decentralized financial investment system 1 based on blockchain comprises a computer device 12 in risk investment end, a computer device 14 in fixed income end, a quantitative platform, such as, mirror trading platform, escrow trading platform, 16, and smart contract 10.

The computer device 12 in risk investment end includes a first user interface program 120 for a risk taker 6 to set subscription quantities of risk investment units 1200 and execute through the first user interface program 120 to allow the computer device 12 in risk investment end execute the high leverage risk trading provided by the quasi-decentralized financial investment system 1 based on blockchain.

The computer device 14 in fixed income end includes a second user interface program 140 for a fixed income holder 8 to set subscription quantities of fixed income units 1400 and execute through the second user interface program 1400 to allow the computer device 14 in fixed income end execute the low risk monthly profit trading provided by the quasi-decentralized financial investment system 1 based on blockchain. The two types of users of the risk decomposition system can be the fixed income holder 8 and the risk trader 6.

It is needed to be explained that the investment targets of the risk investment units 1200 and the fixed income units 1400 include cryptocurrency, traditional investment targets, such as stocks, bonds, futures, options, financial derivatives, or other financial products, etc.

The quantitative platform 16, such as, mirror trading platform, escrow trading platform, stores selective investment strategy program 1600 for executing high leverage risk trading.

The smart contract 10 is connected to the computer device 12 in risk investment end, the computer device 14 in fixed income end, and the quantitative platform 16, such as, mirror trading platform, escrow trading platform, respectively, for data exchange processes.

The smart contract 10 further includes risk collateral module 102 and investment interest exchange contract module 104, wherein first monetary amount 1022 corresponding to subscription quantities of risk investment units 1200 of the risk trader 6, and second monetary amount 1024 corresponding to subscription quantities of fixed income units 1400 of the fixed income holder 8 are stored in the risk collateral module 102, data 1042 of Investment interest exchange contract rules between the computer device 12 in risk investment end and the computer device 14 in fixed income end, the computer device 14 in fixed income end and the quantitative platform 16, such as, mirror trading platform, escrow trading platform, and, the computer device 12 in risk investment end and the quantitative platform 16, such as, mirror trading platform, escrow trading platform, are all stored in the investment interest exchange contract module 104. The smart contract 10 executes capital gains distribution of the first monetary amount 1022 and the second monetary amount 1024 stored in the risk collateral module 102 according to the data 1042 of investment interest exchange contract rules.

The computer device 12 in risk investment end can include but not be limited to desk-top computer, laptop, smart phone, Tablet PC, etc.

The first user interface program 120 included in the computer device 12 in risk investment end is for the risk taker 6 to set subscription quantities of risk investment units 1200 and execute through the first user interface program 120 to allow the computer device 12 in risk investment end execute the high leverage risk trading provided by the quasi-decentralized financial investment system 1 based on blockchain.

That is, the trading strategy or trading product provided by the computer device 12 in risk investment end is the financial investment product especially for the high risk taker 6, high risk means higher returns and high leverage is suitable for the risk taker 6 to invest the tradable asset.

It is needed to be specifically explained that the risk taker 6 sets subscription quantities of risk investment units 1200 through the first user interface program 120 and execute, and can use fiat currency, cryptocurrency or quasi money to subscribe, wherein the quasi money subscription is such as investment points subscription, member points subscription, etc.

The first user interface program 120 is for the risk taker 6 to set subscription quantities of risk investment units 1200. For example, if the unit price is 100 USTD (Tether USD), the risk taker 6 wants to subscribe 8 units, and, then, must transfer 800 USDT to the computer device 12 in risk investment end to accomplish the subscription. And, that means the risk taker 6 invests 800 USDT to execute the high leverage risk trading provided by the quasi-decentralized financial investment system 1 based on blockchain.

The cryptocurrency in the present invention is not limited to USDT, but also can be other cryptocurrency, such as Bitcoin, Ethereum, Ripple, Litecoin, etc.

In the present invention, the investment units can be established at fiat currency such as, USD, etc. The quasi-decentralized financial investment system 1 based on blockchain can convert the fiat currency to cryptocurrency to execute the trading investment. When the liquidation process of the trading investment is processed, the quasi-decentralized financial investment system 1 based on blockchain can convert the cryptocurrency to the fiat currency. Meanwhile, in the same way, the quasi currency can be used to execute the trading investment and the liquidation process.

In the same way, the computer device 14 in fixed income end can include but not be limited to desk-top computer, Laptop, smart phone, Tablet PC, etc.

The second user interface program 140 included in the computer device 14 in fixed income end is for the fixed income holder 8 to set subscription quantities of fixed income units 1400 and execute through the second user interface program 140 to allow the computer device 14 in fixed income end execute the low risk monthly profit receiving in trading provided by the quasi-decentralized financial investment system 1 based on blockchain.

That is, the trading strategy or trading products provided by the computer device 14 in fixed income end is specially for the fixed income holder 8 preferring stable income with low risk, low risk meaning lower returns than the returns in high leverage trading is suitable for the fixed income holder 8 to invest the tradable asset.

It is needed to be specifically explained that the fixed income holder 8 sets subscription quantities of fixed income units 1400 and execute through the second user interface program 140, and can use fiat currency, cryptocurrency or quasi money to subscribe, wherein the quasi money subscription is such as investment points subscription, member points subscription, etc

The second user interface program 140 is for the fixed income holder 8 to set subscription quantities of fixed income units 1400. For example, if the unit price is 1000 USTD (Tether USD), the fixed income holder 8 wants to subscribe 8 units, and, then, must transfer 8000 USDT to the computer device 14 in fixed income end to accomplish the subscription. And, that means the fixed income holder 8 invests 8000 USDT to execute the low risk monthly profit receiving in trading provided by the quasi-decentralized financial investment system 1 based on blockchain.

The cryptocurrency in the present invention is not limited to USDT, but can be other cryptocurrency, such as Bitcoin, Ethereum, Ripple, Litecoin, etc.

In the present invention, the investment units can be established at fiat currency such as, USD, etc. The quasi-decentralized financial investment system 1 based on blockchain can convert the fiat currency to cryptocurrency to execute the trading investment. When the liquidation process of the trading investment is processed, the quasi-decentralized financial investment system 1 based on blockchain can convert the cryptocurrency to the fiat currency. Meanwhile, in the same way, the quasi currency can be used to execute the trading investment and the liquidation process.

It is to be mentioned that under the system structure constructed by the present invention, there is a multiple leverage relationship between the subscription price of the unit price of the risk investment units 1200, and the subscription price of the unit price of the fixed income units 1400.

The multiple leverage is between 5 to 20, and the selected investment strategy program 1600 used for executing high-leverage risk trading tends not to trigger an early terminating condition and execute an early liquidation due to trader's poor performance.

For the example mentioned above, the subscription price of the unit price of the risk investment units 1200 is 100 USDT, and the subscription price of the fixed income units 1400 is 1000 USDT. That is, the subscription price of the fixed income units 1400 is 10 times than that of the unit price of the risk investment units 1200. And under this situation, the multiple leverage of the high leverage risk trading provided by the quasi-decentralized financial investment system 1 based on blockchain of the present invention is 10.

As for the quantitative platform 16, such as, mirror trading platform, escrow trading platform, the quantitative trading strategy is a investment method by using automated program with the help of modern statistics and mathematics to execute trading. The selected investment strategy program 1600 stored in the quantitative platform 16, such as, mirror trading platform, escrow trading platform, of the present invention used for executing high-leverage risk trading can be one of or a combination of Artificial Intelligence programs, empirical logic programs, trading logic programs, and programs based on mathematical models.

A risk investment computer device used for providing a risk taker to execute the high-leverage risk trading would be executed by the selected investment strategy program 1600, and in particular, the selected investment strategy program 1600 can be maintained and updated by a professional trading team. And that is, the selected investment strategy program 1600 can be updated and modified according to the market mechanism and changes in the market without keeping the same trading strategy.

The smart contract, in short, is a special protocol used in blockchain in the development of contracts, primarily to provide verification and execution of the conditions and terms defined in the smart contract. In addition, smart contracts are defined by the creator and constructed by blockchain network execution, wherein all messages related to the contract conditions and terms are automatically executed according to the actions set in the contract.

In the present invention, the smart contract 10 is connected to the computer device 12 in risk investment end, the computer device 14 in fixed income end, and the quantitative platform 16, such as, mirror trading platform, escrow trading platform, respectively, for data exchange processes. The smart contract 10 further includes risk collateral module 102 and investment interest exchange contract module 104.

For more details, the first monetary amount 1022 corresponding to subscription quantities of risk investment units 1200 of the risk trader 6, and the second monetary amount 1024 corresponding to subscription quantities of fixed income units 1400 of the fixed income holder 8 are stored in the risk collateral module 102 of the smart contract 10. As for the example mentioned above, the first monetary amount 1022 invested by the risk trader 6 is 800 USDT, and the second monetary amount 1024 invested by the fixed income holder 8 is 8000 USDT.

The investment interest exchange contract module 104 stores data 1042 of investment interest exchange contract rules corresponding to the computer device 12 in risk investment end, the computer device 14 in fixed income end, and the smart contract 16.

The data 1042 of investment interest exchange contract rules records various caution notes of the financial investment, and related payment and disbursement, profit-splitting, and so on.

According to the data 1042 of investment interest exchange contract rules, the smart contract 10 executes a distribution of profits on the basis of the first monetary amount 1022 and the second monetary amount 1024 stored in the stored in the risk collateral module 102.

Through the structure of the smart contract 10, the distribution of profits is automatically executed according to trading terms of the data 1042 of investment interest exchange contract rules, and the trading terms of agreement are immutable, and all the activities are actively collected in the blockchain for viewing, which are traceable, immutable and irreversible, and enable the computer device 12 in risk investment end and the computer device 14 in fixed income end to execute profit sharing according to the smart contract, effectively preventing any respective parties from not executing contract and avoiding the risk of financial fraud.

An embodiment is to describe practical investment operation processes based on the quasi-decentralized financial investment system 1 based on blockchain of the present invention.

The quasi-decentralized financial investment system 1 based on blockchain of the present invention is a quasi-decentralized financial investment system to satisfy requirements of the computer device 12 in risk investment end and the computer device 14 in fixed income end, and simultaneously to integrate the high risk investment strategy for the computer device 12 in risk investment end, and the low risk investment strategy for the computer device 14 in fixed income end.

That is, the purpose of the cryptocurrency invested by the risk taker 6 through the computer device 12 in risk investment end is to increase leverage investment to maximize profits, and the cryptocurrency invested by the fixed income holder 8 through the computer device 14 in fixed income end is collateralized to receive fixed interest rate.

In this embodiment, if a contract period of the smart contract 10 of the quasi-decentralized financial investment system 1 based on blockchain is 6 months and the investment performance of the smart contract 10 can guarantee and reach an annualized rate of return of 12% for the fixed income holder 8 through the computer device 14 in fixed income end, it needs 1000 USDT invested by the fixed income holder 8 to subscribe 1 unit of the investment product.

That is, after the fixed income holder 8 invests 1000 USDT to subscribe 1 unit of the investment product, the 1 unit earns the fixed income holder 8 10 USDT risk free per month in interest for 6 months, or, after 6 months, the smart contract 10 is terminated and the fixed income holder 8 receives 60 USD for interest payment (contract period, half year, annual interest rate, 12%). And The 1000 USDT invested by the fixed income holder 8 as the collateralized property is stored in the risk collateral module 102. The interest payment made every month, or made once after the smart contract expiry date can be read in the data 1042 of investment interest exchange contract rules of the smart contract 10 to make an appointment.

It is needed to be mentioned that the annual interest rate 12% for the fixed income holder 8 in the computer device 14 in fixed income end is not negotiated and determined by the computer device 12 in risk investment end and the computer device 14 in fixed income end, and, however, the annual interest rate is changed based on the increased demand. If the trend of the overall cryptocurrency gradually has slowed down, and even begins to enter a slow-down and consolidation phase, the market liquidity and arbitrage space become smaller; the annual interest rate may be less than 12%.

On the other hand, the risk taker 6 in the computer device 12 in risk investment end just needs to pay a small amount of funds to get the encrypted assets lent by the fixed income holder 8 through the computer device 14 in fixed income end, and, through high multiple leverage, can maximize the profits by using the selected investment strategy program 1600 of the quantitative platform 16, such as, mirror trading platform, escrow trading platform.

In this embodiment, the risk taker 6 in the computer device 12 in risk investment end needs to invest 1000 USDT to subscribe 1 unit of the investment product. That is, after subscribing 1 unit of the investment product, the risk taker 6 can own the investment rights of the encrypted assets (encrypted assets, 1000 USDT) lent by the fixed income holder 8 in the computer device 14 in fixed income end, and the leverage ratio is 10 times.

Generally speaking, the investment funds (100 USDT) invested by the risk holder 8 in the computer device 12 in risk investment end will be divided into the following 3 uses:

1. For example, 60% of the investment funds (60 USDT) is used as loan interest paid to the fixed income holder 10 through the computer device 12 in fixed income end.

2. 30% of the investment funds (60 USDT) is used as the margin stake, and serves as the margin stake for the selective investment strategy program 1600 to approach profit or loss. When the strategy is terminated, there is a positive return, the margin stake will be returned to the risk holder 6 in the computer device 12 in the risk investment end.

3. The platform of the quasi-decentralized financial investment system based on blockchain receives platform fee from both the fixed income holder's and the risk taker's investment. 10% of the investment funds (60 USDT) is used as the platform management fees.

If the selective investment strategy program 1600 is to receive a 30% annual return, the computer device 12 in risk investment end can receive 150 USDT profit during the 6-month contract period, and, however, the computer device 12 in risk investment end only invests 100 USDT, but can invest 1000 USDT lent by the computer device 14 in fixed income end and receives the profits by using the selected investment strategy program 1600 to earn a 30% annual return. In other words, this means that the investment return rate in the computer device 12 in risk investment end is the annualized return rate which is 100%.

It should be noticed that if the performance of the selective investment strategy program 1600 is negative or under expected, it is possible to execute a liquidation process and the risk taker 6 in the computer device 12 in high risk investment end will lose all of his assets, 100 USDT, and, however, the smart contract 10 will always guarantee that the fixed income holder 8, the asset lender, receives his interests during settlement periods.

As mentioned in the above, the multi-leveraged investment product provided by the quasi-decentralized financial investment system 1 based on blockchain of the present invention is suitable for the risk takers 6 who is pursuing high-risk and high-reward. The risk taker 6 initially inputs a small amount of cryto assets to gain access to a greater amount provided by the fixed income holder 8 in the computer device 14 in fixed income end, and to gain full rights to the investment equity.

The computer device 14 in fixed income end provides crypto assets to the the selective investment strategy program 1600. At the end of the contract period, the fixed income holder 8 can recover 100% of his lending crypto assets without the risk of loss.

In the embodiment, the fixed income holder 8 in the computer device 14 in fixed income end can earn a stable 12% annual return rate within half a year. The risk taker 6 in the computer device 12 in risk investment end does not to pledge an over-collateralized amount of crypto assets to the selective investment strategy program 1600, and can own the investment rights of the encrypted assets 10 times than the crypto assets invested by the risk taker 6 to maximize the profits.

By extending the concept of a decentralized lending platform, the quasi-decentralized financial investment system 1 based on blockchain of the present invention brings in more traditional investors with conservative investment styles, and can simultaneously satisfy investors with different risk tolerances to meet two extreme needs of two types of investors—the fixed income holder who pursues low-risk, stable returns, and the risk taker who is willing to take on more risk for higher returns.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A quasi-decentralized financial investment system based on blockchain, applicable to a blockchain network executing a smart contract, comprising:
a computer device in risk investment end including a first user interface program for a risk taker to set subscription quantities of risk investment units and execute through the first user interface program to allow the computer device in risk investment end execute the high leverage risk trading provided by the quasi-decentralized financial investment system based on blockchain;
a computer device in fixed income end including a second user interface program for a fixed income holder to set subscription quantities of fixed income units and execute through the second user interface program to allow the computer device in fixed income end execute a low risk monthly profit trading provided by the quasi-decentralized financial investment system based on blockchain;
a quantitative platform stored a selective investment strategy program for executing high leverage risk trading; and
the smart contract connected to the computer device in risk investment end, the computer device in fixed income end, and the quantitative platform respectively, for data exchange processes,
wherein the smart contract further includes risk collateral module and investment interest exchange contract module,
wherein first monetary amount corresponding to subscription quantities of risk investment units of the risk trader, and second monetary amount corresponding to subscription quantities of fixed income units of the fixed income holder are stored in the risk collateral module,
wherein data of investment interest exchange contract rules between the computer device in risk investment end and the computer device in fixed income end, the computer device in fixed income end and the quantitative platform, and, the computer device in risk investment end and the quantitative platform are all stored in the investment interest exchange contract module, and
wherein the smart contract executes capital gains distribution of the first monetary amount and the second monetary amount stored in the risk collateral module according to the data of investment interest exchange contract rules.

2. The quasi-decentralized financial investment system based on blockchain as claimed in claim 1, wherein the selective investment strategy program is an artificial intelligence (AI) program, experience logic program, transaction logic program, mathematical model based program or any combination thereof.

3. The quasi-decentralized financial investment system based on blockchain as claimed in claim 1, wherein a multiple leverage relationship is between subscription price of a unit price of risk investment units and subscription price of a unit price of fixed income units.

4. The quasi-decentralized financial investment system based on blockchain as claimed in claim 3, wherein the multiple leverage is between 5 to 20.

5. The quasi-decentralized financial investment system based on blockchain as claimed in claim 1, wherein the risk taker sets subscription quantities of the risk investment units and execute through the first user interface program, and can use fiat currency, cryptocurrency or quasi money to subscribe, and wherein the fixed income holder sets subscription quantities of the fixed income units and execute through the second user interface program, and can use fiat currency, cryptocurrency or quasi money to subscribe.

6. The quasi-decentralized financial investment system based on blockchain as claimed in claim 1, wherein investment targets of the risk investment units and the fixed income units include cryptocurrency, stocks, bonds, futures, options, financial derivatives, or other financial products.
